(19) United States
(12) Patent Application Publication
(10) Pub. No.: US 2006/0047967 A1
(43) Pub. Date: Mar. 2, 2006

(54) Method and system for data authentication for use with computer systems

(76) Inventors: Mehmet Bilgay Akhan, Camberley (GB); Ahmet Enis Cetin, Ankara (TR); Alptekin Temizel, Guildford (GB)

Correspondence Address: SAWYER LAW GROUP LLP, P O BOX 51418, PALO ALTO, CA, 94303, US

(21) Appl. No.: 11/210,543

(22) Filed: Aug. 23, 2005

Related U.S. Application Data
(60) Provisional application No. 60/605,987, filed on Aug. 31, 2004.

(51) Int. Cl. H04L 9/00

(52) U.S. Cl. 713/176; 713/181

(57) ABSTRACT

Authentication of digital compressed data. In one aspect, a method for securing digital data for authentication includes generating a projection for each compressed video image and a projection hash of each of the projections. A data hash of the compressed video data in each compressed video image is also created. A digital signature is provided for each video image by concatenating the associated projection hash and data hash. The digital signatures are used in the authentication of the digital data.

### CROSS REFERENCE TO RELATED APPLICATIONS

This application claims the benefit of U.S. Provisional Application No. 60/605,987, filed Aug. 31, 2004, entitled, “System for Authenticating Digital Video and Audio for Evidential Admissibility,” which is incorporated herein by reference.

### FIELD OF THE INVENTION

The present invention relates to authenticating data used with computer systems, and more particularly to authenticating video and audio data stored by and retrieved from computer systems.

### BACKGROUND OF THE INVENTION

Authentication of data is used in a variety of applications to ensure that the data has not been tampered with or accessed by unauthorized persons. For example, closed circuit television (CCTV) systems may include digital video cameras and microphones for recording the events occurring in monitored premises for surveillance purposes. The video and audio data such a system records may need to be used as evidence in a court of law, e.g., when a video camera records actions of a person accused of a crime which occurred at a time and place that was recorded by the system. When video and audio data is presented as evidence in a court of law, the prosecution needs to prove that digital files and data are not tampered with in any way. In addition, the judiciary needs to be confident that the digital audio and video files reflect a fair and true representation of the crime scene. The authenticity of the digital evidence presented is essential, since a conviction may be based on that evidence. This is particularly an issue with digital data, which can be more easily altered or changed without leaving traces that such alteration has occurred.

Prior systems have used various techniques to authenticate digital data. For example, in U.S. patent application 2004/0071311, a digital watermarking technique is described. Watermarking inherently requires the insertion of a watermark into the data, and thus results in modification of the image data.

In another authentication technique, a digital signature is extracted from the video data. For example, in U.S. Pat. No. 5,870,471 by Wootton et al., a signature signal is extracted for each image of the video data, from actual image pixels. However, the technique is limited in that it does not consider operating on types of compressed data, e.g., it considers neither intra-frame nor interframe compressed video data.

In another technique, an authentication method is described for MPEG4 surveillance videos. A public domain article entitled, “Authentication of MPEG-4 Based Surveillance Video” by Michael Pramateftakis, Tobias Oelbaum, and Klaus Diepold (IEEE Conference on Image Processing, IEEE Press, 2004) describes this technique, which extracts signature signals from the MPEG compressed video. However, the document fails to describe how and what type of signature signals are extracted from the compressed video. This paper also does not address the issue of the uniqueness of the extracted signatures. For example, the probability of a signature being unique is proportional to the amount of information, and in MPEG encoded video, the amount of information in P- and B-frames is much less than in I-frames. Pramateftakis et al. also do not take into consideration the evidential quality of the synchronized audio data component.

In another authentication technique, a signature of an image is recorded based on randomly determined regions of the image. A public domain document entitled, “Robust Image Hashing,” by R. Venkatesan, S.-M. Koon, M. H. Jakubowski, and P. Moulin (Proc. of IEEE International Conference in Image Processing, IEEE Press, 2000), describes this technique, which divides an image into non-overlapping rectangular regions in a random manner, and variance and mean values of these regions are stored as a signature of the image. However, this method does not describe signatures or authentication for video or its associated audio.

Accordingly, what is needed is a system and method for authenticating compressed video and its associated audio data with a high level of dependability and security for legal admissibility and no alteration of the video and audio data. The present invention addresses such a need.

### SUMMARY OF THE INVENTION

The invention of the present application relates to the authentication of digital compressed data. In one aspect of the invention, a method for securing digital data for authentication includes generating a projection for each compressed video image in compressed video data, the compressed video data included in the digital data. A projection hash of each of the projections, and a data hash of the compressed video data in each compressed video image, are created. A digital signature for each video image is then created by concatenating the associated projection hash and data hash for each video image. The digital signatures are used in the authentication of the digital data when the digital data is exported or examined. Similar aspects of the invention provide a system and computer readable medium for implementing similar features.

In another aspect, a method for authenticating stored digital data includes retrieving the stored digital data from at least one storage medium, where the digital data including compressed video data and encrypted signatures. The encrypted signatures are decrypted. New signatures are generated, by generating a projection for each compressed video image in the compressed video data, creating a projection hash of each of the projections, creating a data hash of the compressed video data in each compressed video image, and creating a digital signature for each compressed video image by concatenating the associated projection hash and data hash for each compressed video image. The decrypted signatures are compared with the corresponding new signatures, such that if any of the decrypted signatures does not match a corresponding new signature, the digital data is considered not authentic.

The present invention provides a secure authentication process that provides signatures for authentication and allows video and audio data to be suitable for evidentiary admissibility in a court of law. Furthermore, the invention does not modify the original digital data in the authentication procedure and can process compressed video and audio data.

### BRIEF DESCRIPTION OF THE FIGURES

FIG. 1 is a block diagram illustrating a system suitable for use with the present invention;

FIG. 2 is a diagrammatic illustration of digital video and audio streams for use with the present invention;

FIG. 3 is a flow diagram illustrating a method of the present invention for generating and storing encrypted signatures used for authenticating the compressed data;

FIG. 4 is a diagrammatic illustration of a typical compressed data packet of the present invention;

FIGS. 5A and 5B are diagrammatic illustrations of the generation of projection matrices for a single image of video data in present invention and the creation of a projection hash for a video image;

FIGS. 6A and 6B are diagrammatic illustrations of the creation of a data hash from the compressed data and the creation of a digital signature.

FIG. 7 is a flow diagram illustrating an authentication and export process of a digital file of the present invention;

FIG. 8 is a flow diagram illustrating a method of the present invention for authentication of exported secured data for evidential quality when viewing the exported secured data; and

FIG. 9 is a diagrammatic illustration of another embodiment of the present invention using an encoding scheme that provides enhancement layers.

### DETAILED DESCRIPTION

The present invention relates to authenticating data used with computer systems, and more particularly to authenticating video and audio data stored by and retrieved from computer systems. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular systems provided in particular implementations. However, one of ordinary skill in the art will readily recognize that this method and system will operate effectively in other implementations. For example, the system implementations usable with the present invention can take a number of different forms. The present invention will also be described in the context of particular methods having certain steps. However, the method and system operate effectively for other methods having different and/or additional steps not inconsistent with the present invention.

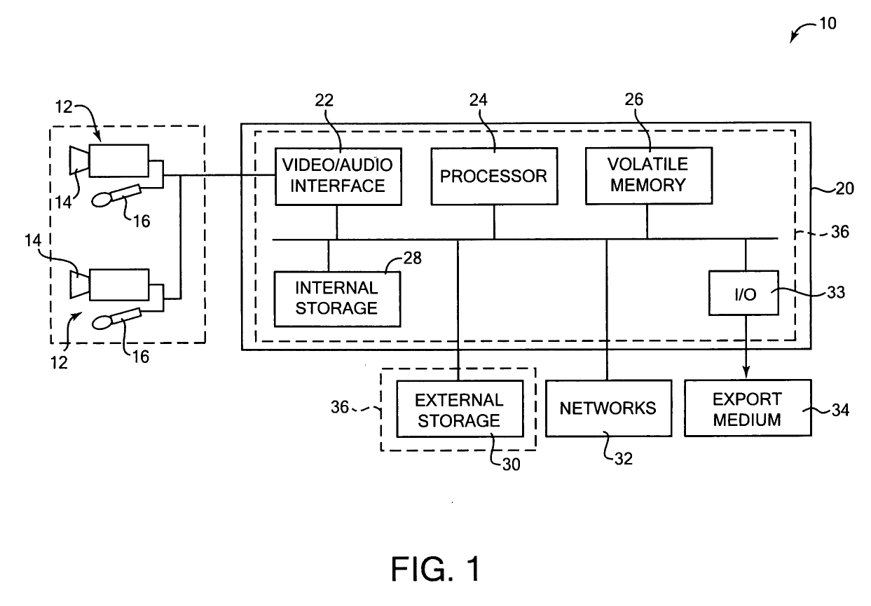

To more particularly describe the features of the present invention, please refer to FIGS. 1-9 in conjunction with the discussion below.

FIG. 1 is a block diagram illustrating a recording system 10 suitable for use with the present invention. System 10 can be a standard video and audio capture and recording system that preferably includes mechanisms to identify mechanical and electronic access to the system by users according to the present invention.

One or more camera systems 12 are provided to capture video images and audio events from the locale in which they are situated. For example, camera system 12 can include a camera 14 that senses the scene at which it is aimed, e.g., a room in a building for security, etc., using well-known image sensing devices. The camera system 12 can also include a microphone 16 for sensing sounds that occur in the vicinity of the microphone.

The camera systems 12 transmit video and audio data to a module 20, which can be a separate module connected to or in communication with one or more camera systems 12, or can be included as part of one or more camera systems 12. Module 20 includes a video/audio interface block 22 for receiving the data from the camera systems 12 and converting them to a data form usable by the storage module 20. In some embodiments, the video/audio interface 22 can receive digital signals from the camera systems 12, or in other embodiments can receive analog signals and convert them to digital form. A processor 24 can control the conversion and storage of the incoming data, as well as other operations of the system 10. The video and audio data can be stored temporarily in volatile memory 26, and/or can be stored in long-term internal storage 28, such as a hard disk. If longer-term storage is desirable for the data, then external storage 30 can be used, such as CD-ROM, tape backup, or other longer-term medium.

The module 20 may also be connected to one or more networks 32, which can provide communication between the module 20 and other devices or computers and/or allow the module 20 to receive data from other devices or computers. For example, the module 20 can transmit stored video and audio data to remote clients over a network. The module 20 can also export audio-video files of data via I/O components 33 to an export medium 34 so that they can be viewed elsewhere using ordinary digital viewing audio-visual equipment and devices. For example, the audio-video files can be exported to a portable hard disk and output on a device such as a personal computer with appropriate software.

For the audio-video data to be of authentic and evidential quality such that it may be used, for example, in a courtroom as evidence, all the devices involved in the system 10, from the point of capture at camera systems 12 to the export of the data to export medium 34, must be tamperproof so that the audio-visual capture and recording is not compromised. Thus, the preferred embodiment of system 10 includes mechanisms adequate to identify mechanical and electronic access to the system. In the described embodiment, such mechanisms include a tamper detecting enclosure 36, indicated by a dashed line around the system 10 and external storage 30. The enclosure 36 is implemented in such a way that any intrusion, such the opening of the enclosure or a panel thereof, is sensed and logged by the system 10, e.g., stored on internal storage 28 and/or external storage 30. In one embodiment, this type of enclosure is achieved by a micro-switch (not shown) fitted to the enclosure and which is contacted or closed when the enclosure is opened.

Electronic access to the various components of the module 20 is possible via ports such as Ethernet and Universal Serial Bus (USB) via networks 32 and/or I/O 33. All electronic accesses are logged in the module 20. The network connection to the module 20 must be secure to ensure that long-term storage media may only be accessed by authorized personnel.

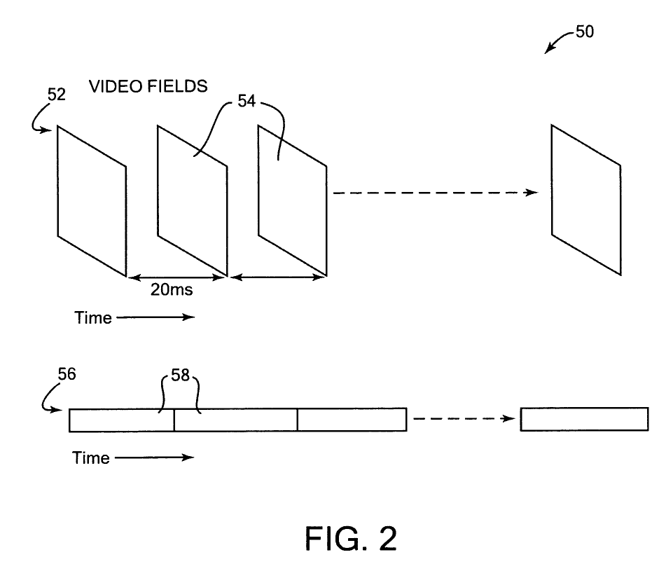

FIG. 2 is a diagrammatic illustration of an example of digital video and audio streams 50 which are captured or converted from analog data and stored during use of the system 10 of FIG. 1.

A digital video stream 52 includes video fields 54, which are individual video images. In this example, each image of video data has a time separation of 20 milliseconds, i.e., an image is captured by the camera system 12 every 20 milliseconds.

An audio stream 56 includes continuous data, with no time separation. Audio stream 56 can be divided into digital audio packets 58. To playback the audio, these audio packets 58 are reassembled.

In one embodiment, upon arrival at the module 20, both streams 52 and 56 are digitized and subsequently compressed. There are a number of motion-compensated compression methods suitable for use with the present invention. The examples described herein relate particularly to the MPEG4 standard. However, those of skill in the art will appreciate that techniques outlined herein are applicable to any motion-compensated or image differencing based compression scheme. For example, MPEG1 or MPEG2 compression algorithms can be used. Audio compression algorithms compress the individual digital audio data packets.

In the case that video and audio is synchronized, video images and digital audio data packets carry data structures to enable this synchronization. Metadata may also be included in digital files that store the video and audio data. For example, metadata may record the date and time of a video stream or video images and/or an audio recording, and/or any other information related to a recording.

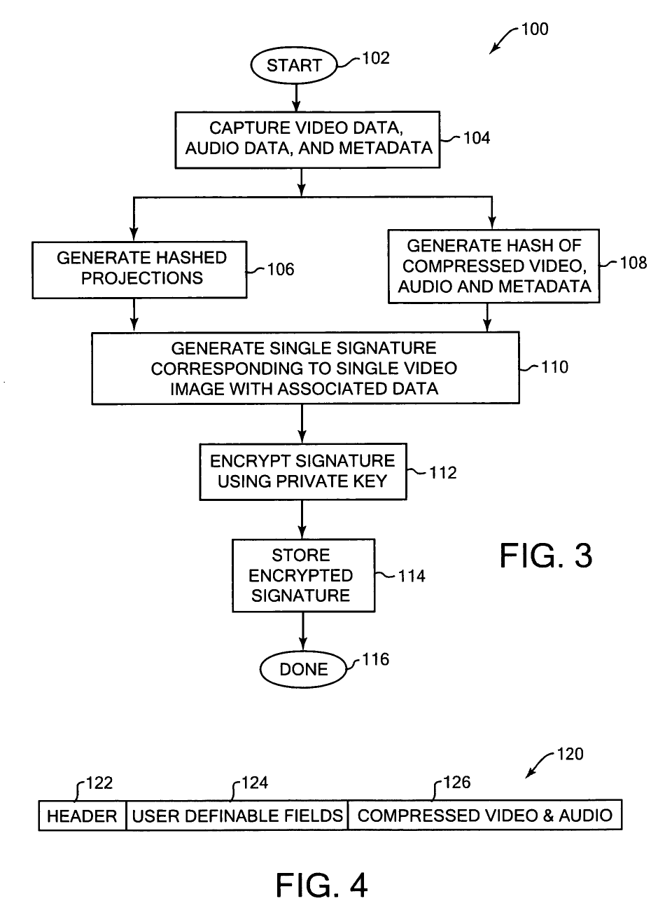

FIG. 3 is a flow diagram illustrating a method 100 of the present invention for generating and storing encrypted signatures used for authenticating compressed digital data. The process can be performed using a video/audio capture apparatus, such as the processor-controlled system 10 described with reference to FIG. 1. Alternatively, the method 100 can be performed by distributed secure components over a network or other system. Method 100, as well as the other methods described herein, are preferably implemented using program instructions (software, firmware, etc.) that can be executed by a computer system such as system 100 and are stored on a computer readable medium, such as memory, hard drive, optical disk (CD-ROM, DVD-ROM, etc.), magnetic disk, etc. Alternatively, these methods can be implemented in hardware (logic gates, etc.) or a combination of hardware and software.

The method begins at 102, and in step 104, the video data, audio data, and metadata are captured, as described above. The metadata can include data such as the date and time when the data was captured, for example. The captured video and audio data may have been previously compressed using well-known compression algorithms as described above, or in other embodiments, the video and audio data can be compressed in step 104. The metadata can also be compressed in some embodiments, but can be stored uncompressed in other embodiments.

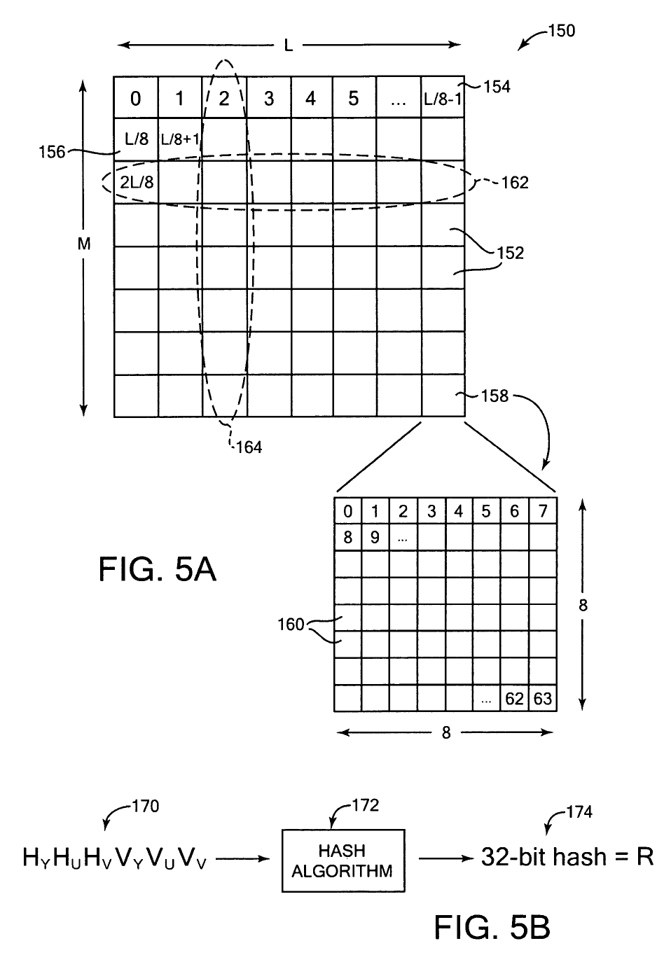

Steps 106 and 108 can be performed in any order or simultaneously, as shown in FIG. 3. In step 106, a hash of projections is generated for a compressed video image. Projections are generated for each video image, and a projection hash R is generated for a video image from the projections for that image. This procedure is described in greater detail below with respect to FIGS. 5A and 5B.

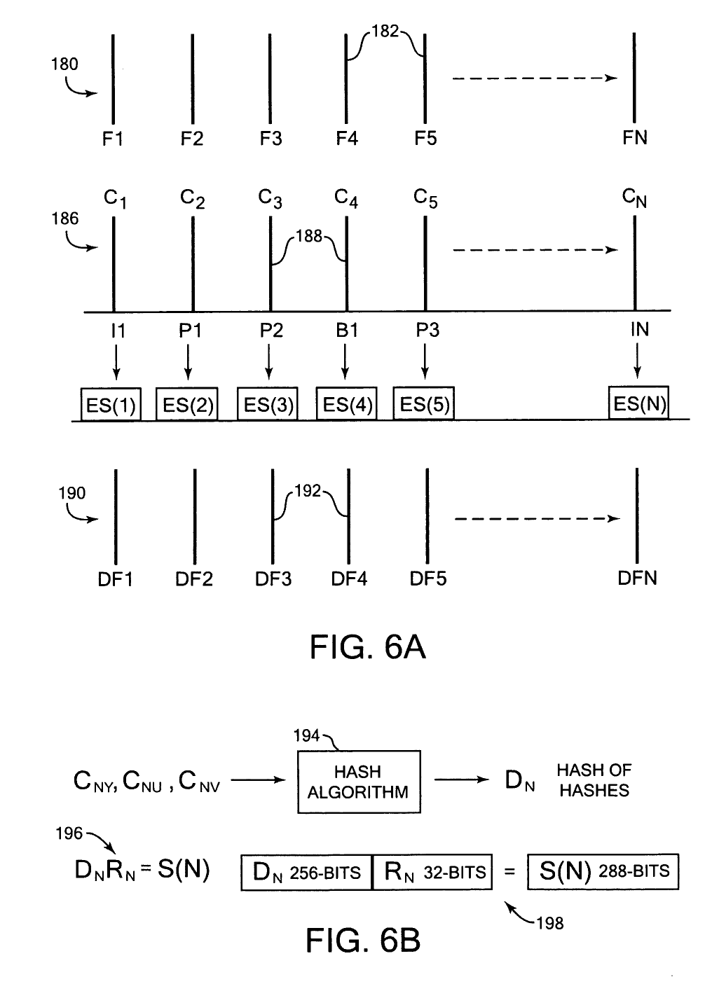

In step 108, a “data hash” D is generated directly using the compressed video data, compressed audio data, and metadata. A data hash is a hash of hashes, where the data hash is made up of multiple hashes C that were each created from the compressed video data for one image and other data. This procedure is described in greater detail below with respect to FIGS. 6A and 6B.

In step 110, a single signature is generated, corresponding to the single video image with associated data that was used to created the hashes of steps 106 and 108. The projection hash R and the data hash D are concatenated to create a unique signature S for a video image. This procedure is explained in greater detail with reference to FIG. 6B. Thus, each video image will have a different, unique signature associated with it.

In step 112, the signature is encrypted, preferably using a private key, to provide an encrypted signature ES. The encryption is performed using any suitable secure encryption algorithm, such as, for example, binary data encryption methods including the United States Advanced Encryption Standard (AES) algorithm and the United States Digital Encryption Standard (DES) algorithm. The encryption algorithm preferably uses a private key for increased security.

In step 114, the encrypted signature is stored for the compressed data, e.g., in internal storage 28 or external storage 30, as shown in FIG. 1. The encrypted signature can be embedded in the data stream or packet with compressed data, or may be stored separate from the compressed data and referenced by that data. The process is then complete at 116.

The process described above can be used to generate a signature for one video image and associated audio data, and then repeated for each video frame and associated audio data to provide multiple signatures for an audio-video stream. In an alternate embodiment, some or all of the steps of the method 100 can each be performed for all the video images before moving to the next step of the process.

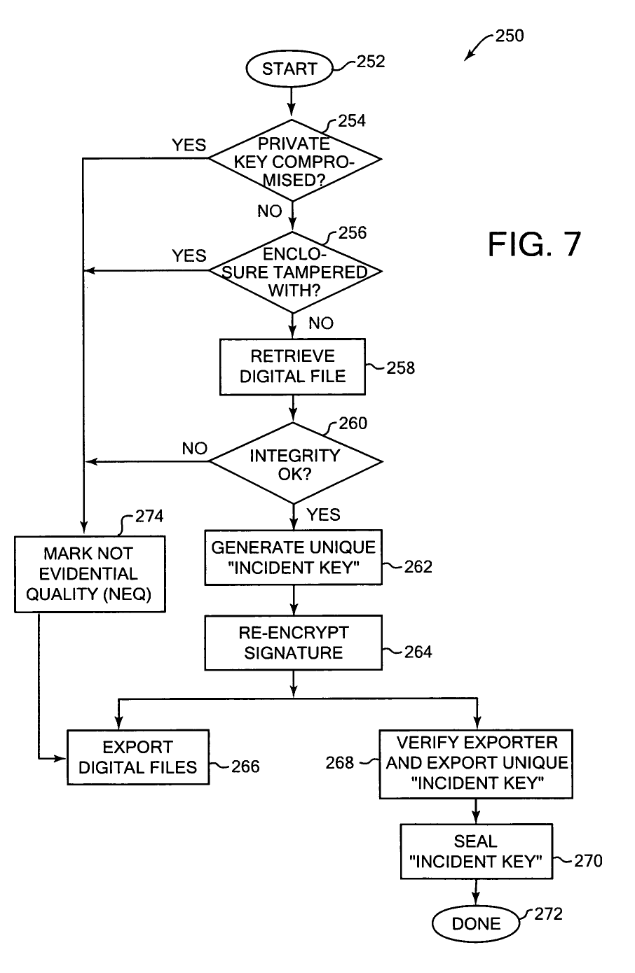

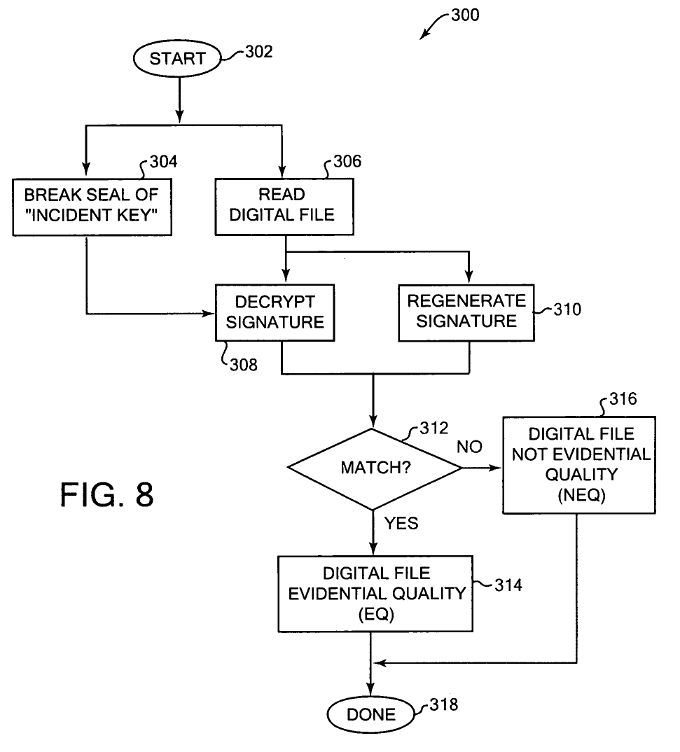

The encrypted signatures are used in the authentication of the compressed video and audio data when that data is to be exported to a medium external to the system 10 and viewed or otherwise accessed. The exporting and viewing processes are described below with reference to FIGS. 7 and 8.

An advantage of the present invention is that it operates on compressed data. Thus, the system does not need to decompress it before authentication. Furthermore, the method does not in any way alter the compressed data nor insert new information into the compressed data, leaving it thus intact and unmodified, as is desired for evidentiary purposes.

FIG. 4 is a diagrammatic illustration of a typical compressed data packet 120 of the present invention. The data packet can include a header 122, user definable fields 124, and compressed audio and video data 126. The user definable fields 124 are used to insert the necessary authentication information (i.e., the encrypted signatures). If user definable fields are not permissible in a particular compression method that is used, then the encrypted signature data can be stored separately in a referenced storage location. The audio and video data portion 126 can include the compressed video data and associated compressed audio data for one or more video images, or in other embodiments can include video/audio data for multiple video images or portions of a video image. Any metadata can be stored, for example, in the user definable fields 124. In some embodiments, audio-video synchronization data also can be stored in the user definable fields 124.

The private key used in the encryption is preferably stored in multiple parts for enhanced security, e.g., stored in at least three parts, in different storage locations known only to the system 10. When the system is powered, these locations can then be checked, and the private key is composed from the separate parts and stored only in volatile memory (such as volatile memory 26 of system 10). The composed private key is preferably never stored in non-volatile memory 28 (such as hard disk) or 30, since such storage could provide insecure access to the key. The locations for the private key are preferably accessed only once, on power up of the system, and further access to these locations are inhibited and monitored by the system. Similarly, all system log files are encrypted and monitored.

FIG. 5A is a diagrammatic illustration of the generation of projection matrices for a single image of video data in present invention, which can be used for step 106 of process 100 of FIG. 3 to create a projection hash for a video image.

To create a projection, an image 150 of video data is divided into blocks 152. In the example shown, image 150 has been divided into 8×8 blocks, so that a length L and a height M of the image 150 produces each block having dimensions of M/8*L/8. Blocks 152 are numbered starting from 0 at the top-corner of the image 150 and increase in value going in a right-to-bottom direction. Thus, the last block 154 in the first row has a number of L/8−1, the first block in the second row has a number of L/8, the first block in the third row has a number of 2L/8, and so on.

Each block 152 includes a number of coefficient values 160, with the coefficient values numbered in a similar fashion as the blocks 152. In the example shown in FIG. 5A, each block has 64 coefficient values 160, as shown for block 158. In alternate embodiments, coefficient ordering can be provided in other ways, such as zigzag scanning processes used in JPEG and MPEG series of coding standards.

A “stripe,” as referred to herein, is a combination of blocks 152. A horizontal stripe 162 with a width of blocks across the width of the image 150 is defined as a union of all horizontal blocks at the same vertical position. A vertical stripe 164 with a height of blocks across the height of the image 150 is defined as a union of all vertical blocks at the same horizontal position. Thus, the image 150 in the example shown includes M/8 horizontal stripes and L/8 vertical stripes.

To create projections for the video image 150, matrices can be used. Let Cᵢⱼ represent the j-th coefficient in the i-th block and Hᵢⱼ represent the projection for the i-th horizontal stripe using the j-th coefficient. Then the projections for the horizontal stripes can be written as:
H_{0,0}=c_{0,0}+c_{1,0}+ . . . +c_{L/8-1,0}
H_{0,1}=c_{0,1}+c_{1,1}+ . . . +c_{L/8-1,1}
H_{0,63}=c_{0,63}+c_{1,63}+ . . . +c_{L/8-1,63}
H_{1,0}=c_{L/8,0}+c_{L/8+1,0}+ . . . +c_{2L/8-1,0}
H_{1,1}=c_{L/8,1}+c_{L/8+1,1}+ . . . +c_{2L/8-1,1}
H_{1,63}=c_{0,63}+c_{1,63}+ . . . +c_{L/8-1,63}
H_{M/8-1,63}=c_{L/8*(M/8-1),63}+c_{L/8*(M/8-1)+1,63}+ . . . +c_{L/8*M/8-1,63}

The above set of equations can be written as:

$${H}_{i , j} = {\sum }_{k} {c}_{i * L / 8 + k , j}$$

where i ε (0,1, . . . , M/8−1),j ε (0,1, . . . , 63) and k ε (0,1, . . . , M/8−1)

A similar operation can be carried out for vertical stripes:

$${V}_{i , j} = {\sum }_{k} {c}_{k * L / 8 + i , j}$$

where i ε (0,1, . . . , L/8−1),j ε (0,1, . . . , 63) and k ε (0,1, . . . , M/8−1)

Then both the horizontal and vertical projection vectors are placed in a matrix which are the signature functions:

$$\begin{matrix}H = [ \begin{matrix}{H}_{0 , 0} & ⋯ & ⋯ & {H}_{0 , 63} \\ ⋮ & ⋰ & & ⋮ \\ ⋮ & & ⋰ & ⋮ \\ {H}_{M / 8 - 1 , 0} & ⋯ & ⋯ & {H}_{M / 8 - 1 , 63}\end{matrix} ] \\ V = [ \begin{matrix}{V}_{0 , 0} & ⋯ & ⋯ & {V}_{0 , 63} \\ ⋮ & ⋰ & & ⋮ \\ ⋮ & & ⋰ & ⋮ \\ {V}_{L / 8 - 1 , 0} & ⋯ & ⋯ & {V}_{L / 8 - 1 , 63}\end{matrix} ]\end{matrix}$$

In the case of color video, the projections as shown above are created for each color component. The example worked out above applies to Y, U, V coded video. Consequently, each image 150 will have six independent projections for color video, as shown below:
H_{T}=[H_{Y}, H_{U}, H_{V}]
V_{T}=[V_{Y}, V_{U}, V_{V}]

Those of skill in the art will appreciate that the same algorithms can be applied to any video color scheme, such as R, G, B, for example. The same algorithms can also be applied for black and white video; there are less independent projections for black and white video (e.g., two).

In Y, U, V color representation, the size of H_{U} and H_{V} matrices can be smaller than the H_{Y} matrix, if color difference images are downsampled horizontally, vertically, or both horizontally and vertically. In memory and computationally efficient applications, both H_{U} and H_{V} matrices can be dropped because the luminance (Y) component of a given image contains the gray-scale information in the original image.

The projection for intra-frame compressed video data (such as I-frames, described below with reference to FIG. 6A) can be extracted by performing the projection operation in the horizontal and/or vertical stripes of the compressed video data (e.g., stripes of Discrete Cosine Transformed video intra-frame image data). The projection for inter-frame compressed video data (such as P-frames and B-frames, described below with reference to FIG. 6A) can be extracted by performing the projection operation in horizontal and/or vertical stripes of video difference image data obtained during the inter-frame compression of some of the images of the video. A projection for each set of motion vectors in P-frames and B-frames can be extracted in any way, including the quantization and binarization of the set of motion vectors. The union of potentially overlapping horizontal and/or vertical stripes of data from the compressed image cover the entire image, whether that image be an intra-frame compressed image (e.g., Discrete Cosine Transformed), or difference image data (e.g., Discrete Cosine Transformed difference image data) obtained during inter-frame compression of some of the image frames of the video data.

FIG. 5B illustrates creating a projection hash for the projections obtained as described above for FIG. 5A. The generated projections 170 as described above are fed into a hashing algorithm 172 that generates a 32-bit length hash 174 of the projections. The projection hash can be considered “R”, a hash of projections for use in the step 110 of FIG. 3 to create a signature for the video image. Other bit-length hashes than length 32 can be used in other embodiments. Furthermore, the projection hash can be fixed length hash or a variable length hash of all the projections for an image.

FIGS. 6A-B are diagrammatic illustrations of the step 108 of FIG. 3 for creating a data hash from the compressed data, and step 110 of FIG. 3, for creating a digital signature. FIG. 6A shows an uncompressed video stream 180, i.e., a digitized stream of video data provided in blocks of fields (images) 182, such as field F1, field F2, etc., up to FN, the Nth field in the stream. Stream 180 represents a single color component of video data, in the embodiment where full color video data is being processed.

Stream 186 is a compressed video stream including compressed fields (video images) 188, such as C1, C2, etc., up to CN, the Nth field in the stream. Each image has been compressed using a particular type of encoding for video. When using the MPEG4 video compression algorithm, for example, two different types of encoding are available: intra-frames (I-frames) and inter-frames. Inter-frames can be in the form of predictive frames (P-frames), and bi-directional frames (B-frames). The type of encoding used can depend on several factors particular to an implementation or desired use, such as the desired compression, compression quality, codec that is used to decompress, etc.

I-frames, such as compressed frame I1 in FIG. 6A, are images that have been compressed using spatial compression to dispose of redundancy in the frame. This compression is accomplished using common compression methods such as block-based Discrete Cosine Transforms (DCTs), Run Length encoding, and Huffman encoding. The mathematical relationship can be summarized as I1=E(F1), where the I-frame I1 is formed from the function E( ), which indicates the encoding of the frame F1.

Inter-frames are images that have been compressed using temporal compression to record changes between frames, and not record complete frames. Typically, the changes between frames are stored as motion vector data in the compressed video data of P-frames and B-frames. Thus this type of encoding generally permits greater compression than with I-frames. Inter-frames include P-frames and B-frames. P-frames are a type of frame which are encoded differently from I-frames. P-frames store the difference between frames, and are built on a previous I-frame or P-frame. For example, a block in the current frame (such as a block in an 8×8 array, 16×16 array, or other size) is chosen, and the most similar block is then searched for in the previous frame. When a sufficiently close match is found, then the difference in pixel values is calculated. Following the differencing, a motion vector is calculated, which specifies numerically the direction and distance the block has moved. Finally, the pixel difference values and motion vector is compressed using a common compression algorithm as described above.

Each P-frame can be mathematically described as a function of previous video images and calculated motion vectors. For example, P-frames P1 and P2 as shown in FIG. 6A can be described as shown below:
P1=G(F2−F1)+M(V)_{G}
P2=G(F3−F2)+L(F3−I1)+M(V)_{G}+M(V)_{L}

The functions G and L are difference functions for the difference in pixel values between the two frames operated on by the function. The M function provides the motion vector for a G difference function or L difference function, as specified.

B-frames are another type of inter-frame which are encoded differently than I-frames and P-frames. B-frames are built on two frames, both previous and future frames with reference to the B-frame itself. B-frames are calculated similarly to the P-frames as described above, except that they have reference to these two frames. A B-frame can achieve more compression than I-frames and P-frames, but may have lower quality.

Each B-frame can be mathematically described as a function of previous and future video images and calculated motion vectors. For example, B-frame B1 as shown in FIG. 6A can be described as shown below:
B1=G(F3−F4)+L(F4−F5)+M(V)_{G}+M(V)_{L}

As shown in FIG. 6A, the compressed I-frames, P-frames, and B-frames are used to determine a signature S for each compressed video image and is encrypted using an encryption algorithm to create an encrypted signature ES(N), for field N of the video stream. As described with reference to FIG. 3, the encryption algorithm preferably uses a private key. The encrypted signatures are stored in a location referenced by the compressed data file.

Stream 190 is an example of a decompressed video stream including decompressed fields 192 resulting from decompressing the compressed data stream 186 after authentication. Decompression of the fields reverses the above-described compression procedures. I-frames can be decompressed independently of other frames, but P-frame compression may require a number of previous P-frames until the closest I-frame. For visually intact decompression, all I-frames and P-frames are required. B-frames are not required for decompression of other frames; thus, B-frames can be discarded after decompression.

The compression and decompression described above is applied to all color components of a video data stream.

As described above, audio is compressed as data packets. Audio compression can include video frame reference information, placed in one or more audio packets and referring to one or more video frames which correspond to that audio packet, to allow synchronization on playback of the video and audio data.

FIG. 6B is a diagrammatic illustration of the creation of a data hash and a signature of the present invention for compressed data. According to a described embodiment of the present invention, a hash is created for each frame of data, e.g., a hash having a fixed length of 128 bits or a variable length between 128 to 256 bits. A “frame” of data includes a compressed video image (an I-frame, P-frame, or B-frame), and may include associated compressed audio data. The hash may be created by any hashing algorithm. For example, the well-known MD4 or MD5 cryptographic hash functions can be used.

The hash for a frame of data is labeled “C” as shown in FIG. 6B. Each hash C carries hash information for a single color component of the video image. Thus, Y,U,V coded video will have three hashes, C_{Y}, C_{U}, and C_{V}, one for each color video component, and all three hashes make up each video image. One of the hashes C for one of the color components includes associated data, such as compressed audio data associated with that image, and metadata for that image, i.e., one of the color components of the compressed video image was combined with the associated data before creating its hash C.

The hashes C_{Y}, C_{U}, and C_{V} for all the color components (and associated data) are concatenated and fed to the same hash algorithm 194 to create a single hash D for one video image (or frame), e.g., for the Nth video image (field), as shown in FIG. 6B. The associated data such as audio data and metadata can be considered similar to a color component for purposes of the concatenation and hash of the concatenated hashes (the associated data is already included in one of the hashes C). In other embodiments, the associated data can be in its own, separate hash C similarly created as the other hashes C, and combined with the video image hashes C, similarly as described above.

The hash D of hashes for the Nth image is concatenated with the previously-created hash of projections, “R,” for the same Nth image, as created in step 106 of FIG. 3 and described above with reference to FIGS. 5A-5B. The concatenated hashes create a single and unique signature S for the associated image, audio, and metadata, as indicated in relationship 196 of FIG. 6B. One example of this process is shown as relation 198 in FIG. 6B, with the data hash D for an Nth compressed image being 256 bits, a projection hash R being 32 bits, and the signature S for the Nth image thus being 288 bits. Those of skill in the art will appreciate that the length of the signature and hashes may be different for different applications or embodiments. One important consideration is that the longer the signature, the greater the probability that the signature is unique.

According to the present invention, the encrypted signatures are embedded with the compressed data. If the compression scheme that is used does not allow such embedding, then the encrypted signatures are stored separately in referenced locations.

Another one of the inventive features of the present invention is the combination of projections with hashes obtained from compressed data. This combination significantly increases the probability of each signature being absolutely unique. Furthermore, the method of creating signatures of the present invention does not in any way alter the compressed data nor insert new information into the compressed data, leaving it thus intact and unmodified, as is desired for evidentiary purposes.

In some embodiments, group signatures can be created for the compressed data to prevent image insertions and deletions from a sequence of images. To create a group signature, a number of consecutive (non-encrypted) signatures S, as created above, are combined and further hashed by a hash algorithm, i.e., a number of already hashed S signatures are combined and hashed again to get a single hashed value. For example, three signatures can be combined and hashed. The resulting group signature is encrypted the same way as the single signature as described above. The group signatures can be embedded with the compressed data, or stored separately from the compressed data, similar to the signatures. When using group signatures, for an image to be qualified as authentic, both the relevant signatures and group signatures must match their re-generated corresponding signatures (described below).

FIG. 7 is a flow diagram illustrating an authentication and export process 250 of a digital file of the present invention. The digital file includes the compressed video and audio data and encrypted signatures created as described above, and is being exported for use by an authorized user.

The process begins at 252, and in step 254, it is checked whether the private key has been compromised. The private key is unique to the system, so that other systems have different private keys. The system 10 checks accesses to the locations where the parts of the private key are stored as described above. If any unauthorized accesses are traced (e.g., stored in a system log file), then the private key is considered to be compromised, and the process continues to step 274, described below.

If the private key is not compromised, then the process continues to step 256, in which it is checked whether there have been any unauthorized intrusions to the system storing the secure data files, physically or electronically, i.e., whether there has been any tampering logged by the system. Physical intrusion refers to physical opening of the enclosure where the data files are stored. Electronic intrusion refers to any access to the storage device/medium holding the files and/or to the system files via any of the system ports, such as via a network, serial port, Universal Serial Bus (USB) port, etc. The status of authorized port accesses can be checked. As described above with reference to FIG. 1, one embodiment provides an enclosure that can detect if it is physically opened or tampered with by a user. If any unauthorized intrusion has been detected, then the process continues to step 274, described below.

If no unauthorized intrusion is detected, then the requested video and audio data (in the digital file) are prepared for export. This includes, in step 258, retrieving the digital file from internal or external storage, where it has been stored. In step 260, the integrity of the digital file is checked. This is accomplished by regenerating (new) signatures in exactly the same way as was performed when creating the signatures for the file. At the same time, the stored encrypted digital signatures are decrypted (if the stored encrypted signatures are embedded in the compressed data, they are extracted from the compressed data and decrypted). The regenerated signatures are then compared to the decrypted signatures. All of the signatures in the file are compared this way, for every video image in the file. Note that if group signatures are used, both the signatures and the group signatures are compared between regenerated and decrypted versions. If the signatures do not match, then the integrity of the digital file is compromised, and the process continues to step 274, described below.

If all the signatures do match, then the data file is considered to have integrity, and the process continues to step 262, in which a unique “incident key” is generated. The incident key is unique to and different for each individual export process. The incident key is then used to re-encrypt the decrypted signatures for export, in step 264.

The digital files are exported in step 266 to the requestor. The export can be, for example, writing the digital files to a medium that is accessible to another device, or to a portable medium which can be provided to another device, such as CD, DVD, USB memory stick, flash memory, etc. Alternatively, the files can be streamed over a network. At the same time, or prior to the export, in step 268 the incident key is exported onto the same medium as the file is exported to in step 266, or the incident key is exported to a separate medium, e.g., a portable medium, such as a floppy disk, removable memory card, USB memory stick, etc. For example, a separate export location for the incident key can offer operational compliance with existing security procedures. The export of the incident key is performed under controlled secure conditions with authorized personnel present; the authorized personnel ensure that the incident key is only given to bona-fide security personnel.

The incident key is exported under controlled conditions. Before export, in step 268 the exporter (owner of the incident key export channel) is verified as authorized by a separate authentication process or export authenticator. This authentication process may include dual passwords, biometric verification, and/or digital certificate of authority or digital signature. The exporter's identity is thus challenged by the system, and the system exports the incident key only to the respondents whose identity is correct as determined by the system.

After export of the incident key, in step 270 the incident key is sealed for transport, and access to the incident key should be restricted. For example, when used for evidentiary purposes in a court trial, the portable medium holding the incident key is sealed in an evidence bag by authorized personnel. The process is then complete at 272.

If the digital files are found to be compromised or their security suspect in steps 254, 256, or 260, then the process continues to step 274, in which the digital data is marked as “not evidential quality” in a standard fashion. In some embodiments, if one or more digital video images or data packets did not have recorded signatures that matched the regenerated signatures in step 260, then only those particular non-matching video images or data packets can be marked as not having evidential quality. The process then continues to step 266 to continue the export of the data. However, since it has been marked as non-evidential, the exported data will not be able to be used in an evidentiary fashion or for another purpose requiring authenticated data.

A loss of the incident key is not critical and is not a cause for a loss of authentication, since each incident key is unique to each export process. The incident key alone does not offer any insight to the authentication process. Collecting a number of incident keys from a series of export processes would also not offer any insight, since the incident keys do not correlate in any way. The incident key is generated uniquely and randomly for each export process.

In many instances, video and audio data may need to be transcoded into any one of the commonly known file formats, e.g., if the receiving device can read only particular formats. In such a case, the system 10 can transcode the video data into a standard format such as JPEG, MJPEG, or AVI, for example. Audio files may be transcoded into a standard format, such as MP3 or GSM format, for example. While transcoding the data, the same procedure as described above for step 260 is used to check of the integrity of the data files that are being transcoded. The final encoded stream should be viewable by any commonly available viewing apparatus or software.

If tampering with exported digital files is suspected, a new export process under controlled conditions can be scheduled. The resulting exported files can then be inspected for tampering.

FIG. 8 is a flow diagram illustrating a method 300 of the present invention for authentication of exported secured data for evidential quality when viewing the exported secured data. This method can be performed by a viewing apparatus that can present the digital data to a user, such as a computer system or electronic device able to read the format of digital data. The viewing of the files is not restricted in any way.

The method begins at 302, and in step 304, the seal of the incident key is broken. If the incident key is stored on the same medium as the video and audio data, then the viewing system can find the incident key automatically, e.g., the incident key can be stored in a predetermined standard location on the medium. If the incident key is stored on a portable medium and secured physically, e.g., in an evidence bag, then the physical security is broken and the portable medium storing the incident key is provided to the viewing system to be read by that system.

Prior to, during, or after the breaking of the incident key, the viewing system reads the digital file in step 306 from the storage medium the digital file was exported to in the method 250 of FIG. 7. The viewing system then decrypts the signatures of the digital file in step 308 using the incident key as indicated in FIG. 8 (when the encrypted signatures are embedded with the compressed data, the signatures are extracted from the compressed data and decrypted). In addition, the viewing system generates the signatures of the digital file in step 310 by dynamically calculating the signatures using the same procedure as described above with reference to FIG. 6B. Step 310 can be performed before, during, or after the execution of step 308.

In step 312, the system compares the re-generated signatures of step 310 to the decrypted signatures of step 308. If the signatures match, then the process continues to step 314, in which the digital file is determined to be of evidential quality, and is presented to the user as such. The process can also mark the file as having evidential quality. The process is then complete at 318. If the signatures do not match in step 312, then the process continues to step 316, in which the digital file is determined to be of non-evidential quality and is presented to the user as such. In addition, the necessary files for the digital data are marked (e.g., with data written to the files) to indicate the non-evidential quality of this data. The process is then complete at 318.

When a remote client requests the secured data, the data is streamed to the client and authentication information is invisible to the client decoder. After the data has been authenticated, the client decoder discards or strips any embedded authentication information from the data (such as the encrypted signatures) and decodes the data for display purposes. The decoder can be designed to handle both embedded and separately stored or transmitted authentication information, based on the format received. For export, the remote client uses the same procedures as the main (server) machine. Authentication information, whether it is embedded in the data stream or stored separately, is used only for checking the authenticity of the data.

In some embodiments, the system 10 can send or stream the compressed data to a remote client and can rearrange the authentication data prior to sending so that it does not interfere with the decompression of the streamed data performed by the decoder. For example, embedded authentication information can be stripped out and placed at the beginning of the compressed video data stream. In other embodiments, the decoder or other process on the receiving client can perform this rearrangement of the authentication data. This rearrangement is not necessary in embodiments where the authentication data is not embedded with the compressed video data.

In an alternate embodiment using non-compressed digital data, the same method of digital signature extraction and decryption for authentication as described in the embodiments above can be used on the non-compressed data.

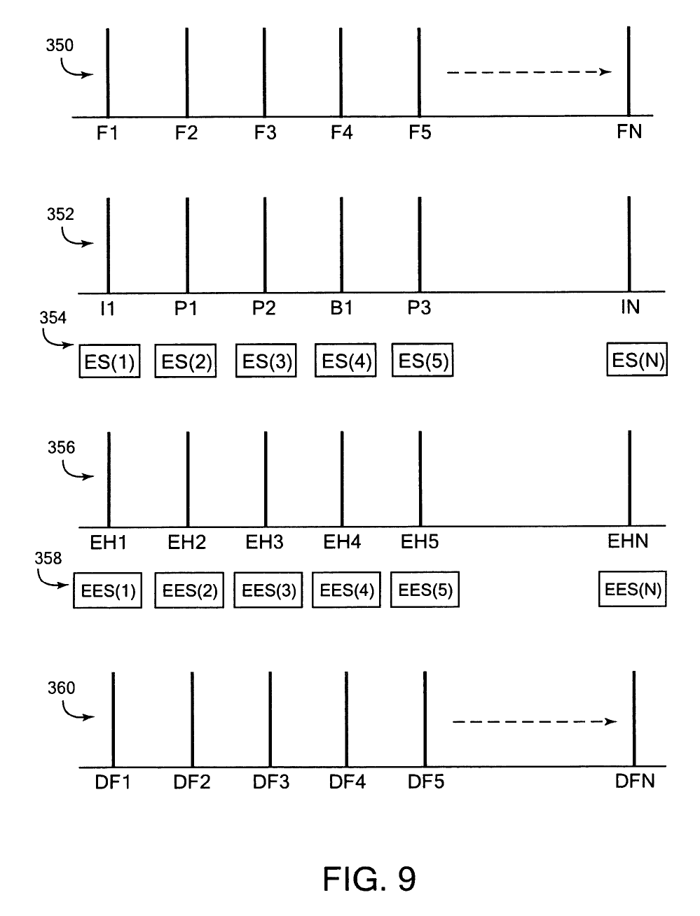

FIG. 9 is a diagrammatic illustration of another embodiment of the present invention using an encoding scheme that provides enhancement layers. An enhancement layer offers additional resolution accuracy to a decompressed image. The loss of enhancement layer data reduces the resolution of images and degrades the image quality, but does not render the normal compressed data unusable. For example, MPEG4 and similar standard differential encoding schemes offer enhancement layers.

The present invention processes enhancement layers in the same way as non-enhanced data as described above. An uncompressed video stream 350 includes fields F1, F2, etc., up to FN (stream 350 represents a single color component of video data, in the case of full color video data). The main layer of the video stream is compressed using motion compensation to achieve the compressed video stream 352, including I-frames, P-frames, and/or B-frames. Signatures are created for each field as described above with respect to FIG. 6B, and the signatures of the main layer are encrypted using the same encryption algorithm as described above, to result in an encrypted signatures 354.

The enhancement layer is similarly processed. The enhancement layer of the video stream is compressed using motion compensation to achieve the compressed enhancement layer video stream 356, signatures are created for each enhancement layer field as described above, and the signatures of the enhancement layer are encrypted using the same encryption algorithm as described above, to result in an enhancement encrypted signatures 358.

Enhancement layer encrypted signatures are kept with enhancement layer compressed data. The enhancement encrypted signatures can be embedded and stored in the non-volatile storage medium with their associated enhancement frames, or the enhancement encrypted signatures can be stored in a separate, referenced non-volatile memory location or storage medium, similar to the main layer as described above. In addition, as the enhancement layer signatures are generated solely using the enhancement layer data, the process can ensure that there is no interdependency of the enhancement layer with the main data layer. Enhancement layers not having any such interdependency are well known. If there is any interdependency, then this data can not be discarded; however, non-interdependent enhancement layer data is always discardable.

A decompressed video stream 360 results from decompressing the encrypted signatures and enhancement encrypted signatures of the compressed data. Decompression of the frames reverses the above-described compression procedures.

The authentication process can be the same as the process described previously. The loss of enhancement layer signatures do not affect the processing of the main data layer. During the authentication process, any mismatches between the enhancement layer exported signatures and dynamically generated signatures are signaled in the same way as non-evidential quality, as described previously.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for securing digital data for authentication, the method comprising:
generating a projection for each compressed video image in compressed video data, the compressed video data included in the digital data;
creating a projection hash of each of the projections;
creating a data hash of the compressed video data in each compressed video image; and
creating a digital signature for each video image by concatenating the associated projection hash and data hash for each video image,
wherein each of the digital signatures is used in the authentication of the digital data when the digital data is exported or examined.

2. The method of claim 1 wherein the digital data includes audio data, and wherein the data hash is created from the compressed video data and associated compressed audio data.

3. The method of claim 1 wherein the digital data includes motion vector data, and wherein the data hash is created from the compressed video data and the motion vector data.

4. The method of claim 1 further comprising encrypting the digital signature for each video image, wherein the encrypted digital signatures are used in the authentication of the digital data.

5. The method of claim 4 wherein each digital signature is unique, and further comprising storing the digital data and the encrypted signatures for the video images on a secure storage medium.

6. The method of claim 4 further comprising embedding the encrypted signature for each video image into the compressed video data and storing the compressed video data and embedded encrypted signatures as a file on a non-volatile storage device.

7. The method of claim 1 further comprising storing the encrypted signature for each video image separately from the compressed video data on a referenced non-volatile storage device and not embedded with the compressed video data.

8. The method of claim 5 wherein the compressed video data is not modified in securing the digital data and in authenticating the digital data.

9. The method of claim 1 wherein the generating of a projection for each video image includes generating a projection from each color component of each video image, and wherein the projection hash is based on a hash of the projections for all the color components of an image.

10. The method of claim 1 wherein the creating of a data hash of the compressed data includes generating a hash for each color component of each compressed video frame, and creating the data hash as a hash of the hashes for each color component.

11. The method of claim 10 wherein at least one of the color component hashes is generated from the compressed data of that color component combined with associated data, the associated data including compressed audio data associated with that video image, and metadata.

12. The method of claim 10 wherein the compressed data that generates the data hash includes at least one I-frame of compressed data.

13. The method of claim 10 wherein the compressed data that generates the data hash includes at least one P-frame of compressed data.

14. The method of claim 10 wherein the compressed data that generates the data hash includes at least one B-frame of compressed data.

15. The method of claim 1 further comprising securing the digital data such that no data can be inserted into or extracted from the compressed video data.

16. The method of claim 1 wherein generating the projection for each compressed video image includes extracting compressed video data by performing a projection operation in horizontal and vertical stripes of the compressed video image.

17. The method of claim 16 wherein the union of horizontal and vertical stripes of data cover an entire compressed video image.

18. The method of claim 1 wherein generating the projection for each compressed video inter-frame image includes extracting compressed video data by performing the projection operation in stripes of video difference image data obtained during the inter-frame compression of some of the images of the video.

19. The method of claim 1 wherein the projection hash is created by performing a projection operation in stripes of compressed video data.

20. The method of claim 19 wherein the projection operation is performed in stripes of video difference image data for compressed P-frames and B-frames of the compressed video data.

21. The method of claim 1 wherein the projection hash and the data hash for each color component of each video image is calculated to be a fixed length.

22. The method of claim 1 wherein the projection hash and the data hash for each color component of each video image is calculated to be a known variable length.

23. The method of claim 4 further comprising exporting the digital data and the encrypted digital signatures from a system storing the digital data and the digital signatures.

24. The method of claim 23 wherein the exporting includes checking the integrity of stored data, including:
decrypting the digital signatures using a private key; and
re-creating the digital signature for each video image and comparing the re-created signature with the decrypted signature for each video image.

25. The method of claim 24 wherein the exporting includes checking the integrity of storage locations of the private key used for decrypting the encrypted digital signatures.

26. The method of claim 25 wherein the exporting includes:
checking the integrity of a storage enclosure of a system storing the compressed video data and digital signatures;
checking the integrity of the storage device storing the compressed video data and digital signatures; and
checking the status of authorized port access to the system.

27. The method of claim 24 wherein the exporting includes:
generating an incident key;
using the incident key to re-encrypt the decrypted signatures; and
exporting the incident key onto an export storage medium, wherein the incident key is used to decrypt the re-encrypted signatures to access the digital data.

28. The method of claim 27 wherein the exporting of the incident key includes exporting the incident key to a portable storage medium that is sealed.

29. The method of claim 27 wherein the exporting of the incident key includes verifying the integrity and owner of the incident key export channel.

30. The method of claim 27 further comprising authenticating the compressed data when viewing the compressed data on a viewing apparatus, including:
accepting the incident key;
using the incident key to check the integrity of the compressed data; and
reporting on the evidential quality of the compressed data.

31. The method of claim 30 wherein checking the integrity of the compressed data includes:
decrypting the digital signatures using the incident key; and
re-creating the digital signature for each video image and comparing the re-created signature with the decrypted signature for each video image.

32. The method of claim 1 wherein the compressed video data includes enhancement layers, wherein encrypted signatures are determined for the enhancement layers to authenticate the enhancement layers.

33. The method of claim 6 further comprising streaming the compressed digital data to a remote client, wherein the embedded encrypted signatures are stripped out and rearranged so as to not interfere with decompression of the compressed digital data at the remote client.

34. The method of claim 1 wherein the compressed video data was compressed using one of the MPEG 1, MPEG 2, and MPEG 4 video compression standards.

35. The method of claim 1 further comprising creating group signatures for the digital data, wherein a plurality of consecutive digital signatures are hashed to create a group signature, and wherein the group signatures are used in the authentication of the digital data when the digital data is exported or examined.

36. A method for authenticating stored digital data, the method comprising:
(a) retrieving the stored digital data from at least one storage medium, the digital data including compressed video data and encrypted signatures;
(b) decrypting the encrypted signatures;
(c) generating new signatures, including:
(i) generating a projection for each compressed video image in the compressed video data and creating a projection hash of each of the projections;
(ii) creating a data hash of the compressed video data in each compressed video image; and
(iii) creating a new digital signature for each compressed video image by concatenating the associated projection hash and data hash for each compressed video image; and
(d) comparing the decrypted signatures with the corresponding new signatures, such that if any of the decrypted signatures does not match a corresponding new signature, the digital data is considered not authentic.

37. The method of claim 36 wherein the digital data includes compressed audio data, and wherein each data hash is created from the compressed video data and associated compressed audio for each compressed video image.

38. The method of claim 36 wherein the authentication of the digital data is performed before the digital data is exported to a storage medium to be accessed.

39. The method of claim 38 wherein the decrypting is performed using a securely stored private key.

40. The method of claim 39 further comprising re-encrypting the digital signatures using an incident key unique to the current exporting process of the digital data.

41. The method of claim 36 further comprising exporting the digital data, the re-encrypted signatures, and the incident key to a storage medium to be accessed.

42. The method of claim 36 wherein the authentication of the digital data is performed after the digital data has been exported to a storage medium and before the digital data is viewed on a viewing apparatus accessing the storage medium.

43. The method of claim 42 wherein the decrypting is performed using a securely stored incident key that was unique to the export process of the digital data.

44. The method of claim 37 wherein each digital signature is unique, and wherein the digital signatures are embedded with the compressed video data and compressed audio data in a file.

45. The method of claim 36 wherein the generating of a projection for each video image includes generating a projection from each color component of each video image, and wherein the projection hash is based on a hash of the projections for all the color components of an image.

46. The method of claim 36 wherein the creating of a data hash of the compressed data includes generating a hash for each color component of each compressed video frame, and creating the data hash as a hash of the hashes for each color component.

47. A computer readable medium including program instructions for securing digital data for authentication, the program instructions for:
generating a projection for each compressed video image in compressed video data, the compressed video data included in the digital data;
creating a projection hash of each of the projections;
creating a data hash of the compressed video data in each compressed video image; and
creating a digital signature for each video image by concatenating the associated projection hash and data hash for each video image,
wherein each of the digital signatures is used in the authentication of the digital data when the digital data is exported or examined.

48. The computer readable medium of claim 47 wherein the digital data includes audio data, and wherein the data hash is created from the compressed video data and associated compressed audio data.

49. The computer readable medium of claim 47 wherein each digital signature is unique, and wherein the program instructions are further for encrypting the digital signature for each video image, wherein the encrypted digital signatures are used in the authentication of the digital data.

50. The computer readable medium of claim 47 wherein the generating of a projection for each video image includes generating a projection from each color component of each video image, and wherein the projection hash is based on a hash of the projections for all the color components of an image.

51. The computer readable medium of claim 47 wherein the creating of a data hash of the compressed data includes generating a hash for each color component of each compressed video frame, and creating the data hash as a hash of the hashes for each color component.

52. A system for securing digital data for authentication, the system comprising:
means for generating a projection for each compressed video image in compressed video data, the compressed video data included in the digital data;
means for creating a projection hash of each of the projections;
means for creating a data hash of the compressed video data in each compressed video image; and
means for creating a digital signature for each video image by concatenating the associated projection hash and data hash for each video image,
wherein each of the digital signatures is used in the authentication of the digital data when the digital data is exported or examined.
